(19) United States
(12) Patent Application Publication
(10) Pub. No.: US 2003/0205101 A1
(43) Pub. Date: Nov. 6, 2003

(54) System and device for remote actuation of a license plate and / or license plate frame

(76) Inventor: Kerwin S. Harmon, Temple Hills, MD (US)

Correspondence Address: Richard C. Litman, LITMAN LAW OFFICES, LTD., P.O. Box 15035, Arlington, VA, 22215, US

(21) Appl. No.: 10/138,575

(22) Filed: May 6, 2002

(51) Int. Cl. F16C 1/12

(52) U.S. Cl. 74/501.6

(57) ABSTRACT

A device to remotely move a license plate of a vehicle from a generally vertical orientation to a generally horizontal orientation in order to prevent mud splatters and to prevent the unwanted observation of alphanumeric information displayed on the license plate by, for example, an aggressive driver. The device includes a support member for securing the license plate to the vehicle and an arm moveable between first and second positions for moving the support member from the vertical orientation to the horizontal orientation. The system includes the device as described above and an actuator for causing the arm to be moved between the first and second positions, wherein the actuator is actuated at a location remote from the license plate.

### BACKGROUND OF THE INVENTION

1. Field of the Invention

The present invention relates to the field of license plates. More specifically, the present invention relates to the field of devices for remotely controlling the movement of license plates and/or license plate frames on a vehicle.

2. Description of the Related Art

For many motor vehicles, license plates are either directly mounted to the rear and/or front end of a vehicle, or are secured to license plate frames that are themselves mounted to the rear and/or front end. In either case, the license plate is generally oriented vertically with respect to the vehicle. However, it would be beneficial for a vehicle operator to be able to place the license plate and/or frame from its normally vertical orientation into a horizontal orientation, without having to stop the vehicle and exit the driver's seat.

When an operator of a vehicle wishes to go “off-roading”, such as driving done on private property in the absence of improved roads, mud splashed onto the license plate from the tires may obscure alphanumeric information displayed by the license plate. If the license plate(s) could be moved to an orientation other than vertical, the splashed mud would tend to not collect on the license plate and cover the alphanumeric information. In such an “offroading” situation, the driver could possibly remove the license plate(s) from the vehicle. However, such a solution is undesirable. It would require the driver to leave the inside of the vehicle and to always have special tools on hand for removing the license plate(s). Additionally, once the vehicle is driven out of the “off-road” area, such as onto a public road, the driver would once again need to leave the inside of the vehicle and reinstall the license plate(s) with the special tools. If the driver failed to reinstall the plate(s), he or she could possibly be cited for failure to display the license plate.

When the operator becomes the object of a case of “road rage” experienced by a driver leading or following the vehicle, the operator again may wish to place the license plate into a hortizontal orientation in order to prevent the aggressive driver from unwantedly observing the alphanumeric information displayed, or instead to display a humorous, non-aggressive message designed to defuse the aggressive driver's attitude. Otherwise, the aggressive driver may use that information against the operator in order to annoy, harass or disturb him or her. Again, the operator has the choice of removing the license plate (s). However, the operator will risk a citation for failure to display the license plate, unless he was able to remotely change the orientation of the license place, such as from inside the driver's compartment.

Thus, those skilled in the art would find useful a device for and system that would allow a driver to move a license plate(s) and/or frame(s) from a generally vertical orientation to a generally horizontal orientation, or to an orientation which is other than vertical. Additionally, those skilled in the art would find useful such a device that could be actuated from a location remote from the license plate(s) and/or frame(s).

Various devices have been proposed for retaining a license plate in a desired orientation or for remotely controlling an aspect or operation of a license plate frame. U.S. Pat. No. 5,192,125 to Gonzalez discloses an apparatus for illuminating a rear license plate. The Gonzalez apparatus includes a frame enclosing a neon light. The neon light may be connected to the lighting system of a vehicle so that the light is powered when the brake pedal is depressed. U.S. Pat. No. 4,257,642 to Sampson discloses a device for holding a spring-hinged gasoline fill cover in a horizontal, refilling position. The Sampson device allows the manually pivoted cover to be retained in the horizontal, refilling position without requiring an operator to hold it in place. Likewise, U.S. Pat. No. 4,390,201 to Saunders discloses a device for holding a license plate in a horizontal position so that a gasoline tank fill neck may be accessed without requiring an operator to contantly hold it in place by hand. Other devices in the field are described in German Patent Publication DE 2 952 226 and U.S. Pat. Nos. 4,750,753 (bumper-mounted folding step) and 5,518,350 (flexible license plate mounting device).

However, none of the above inventions and patents, taken either singly or in combination, is seen to describe the instant invention as claimed. Thus a device and system to remotely actuate a license plate solving the aforementioned problems is desired.

### SUMMARY OF THE INVENTION

The invention is a device for remotely controlling operation of a license plate in order to prevent mud splatters on a license plate and unwanted observation of alphanumeric information displayed on the license plate. The invention also includes a system. The system includes the device as described above as well as an actuator located remote from the license plate. The actuator causes movement of an inventive device thereby preventing the mud splatters and unwanted observation.

A first embodiment of the device is disclosed for remotely controlling movement of a license plate of a vehicle from a generally vertical first orientation to a second orientation which is at an angle to the first orientation. The device includes a support member for supporting the license plate and securing the license plate to the vehicle and an arm engaging the support member. The support member is moveable from the first orientation to the second orientation. The arm is movemeable between first and second positions. Such movement from the first position to the second position causes said support member to be moved from the first orientation to the second orientation.

A second embodiment of the system is disclosed for preventing unwanted observation of alphanumeric information displayed on a license plate of a vehicle. The system incluedes a plurality of louvers adapted for extending across the license plate, a securing member engaging the plurality of louvers, and an actuator adapted for mounting to a driver's compartment of the vehicle. The plurality of louvers are moveable between a first orientation in which the alphanumeric information may be read and a second orientation in which the alphanumeric information may not be read. The securing member is adapted to secure the plurality of louvers to the vehicle. The actuator engages the plurality of louvers, wherein actuation of the actuator causes the plurality of louvers to move from the first orientation to the second orientation.

Accordingly, it is a principal object of the invention to prevent unwanted observation of alphanumeric information displayed upon a license plate, without requiring the operator to leave the vehicle.

It is another object of the invention to provide a device to prevent mud from being splattered on a license plate of a motor vehicle, without requiring an operator to leave the vehicle.

It is a further object of the invention to provide a device for remotely controlling the movement of a license plate on a motor vehicle from a vertical orientation to a horizontal orientation without requiring an operator to leave the motor vehicle.

It also is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a first embodiment of the device for remote actuation of a license plate, according to the present invention, wherein the support member is retained in a generally horizontal orientation by hand, while the arm has been pivoted slightly upward to indicate further features.

FIG. 2 is a perspective view of the first embodiment of the device for remote actuation of a license plate, according to the present invention, wherein the support member is retained in a generally vertical orientation.

FIG. 3 is a perspective view of the actuator for actuating the first embodiment of the device for remote actuation of a license plate, according to the present invention.

FIG. 4 is an environmental, perspective view of a second embodiment of the system for remote actuation of a license plate, according to the present invention.

FIG. 5 is a pespective view of the actuator for the second embodiment of the system for remote actuation of a license plate, according to the present invention.

Similar reference characters denote corresponding features consistently throughout the attached drawings.

### DETAILED DESCRIPTION OF THE PREFERRED EMBODIMENTS

The present invention is a system and device for remotely controlling the movement of a license plate and/or license plate frame from a generally vertical orientation to a generally horizontal orientation, or to a non-vertical orientation intermediate the vertical and horizontal orientations. The inventive system includes an inventive device which performs the movement of the license plate and an actuator which causes the movement of the inventive device. By remotely controlling, it is meant that the movement of the license plate and/or license plate frame into an orientation, as described above, is achieved by actuating the inventive device with an actuator that is positioned at a location remote from the license plate and/or license plate frame. For example, the actuator may be located in a driver's compartment of a vehicle, while the license plate or license plate frame may be located at the front and/or rear end of the vehicle. While the foregoing example is illustrative of the invention, the meanings of “remotely controlling” and “remote” are not limited to such an example, but also include other configurations and positions of the actuator, inventive device and license plate and/or license plate frame.

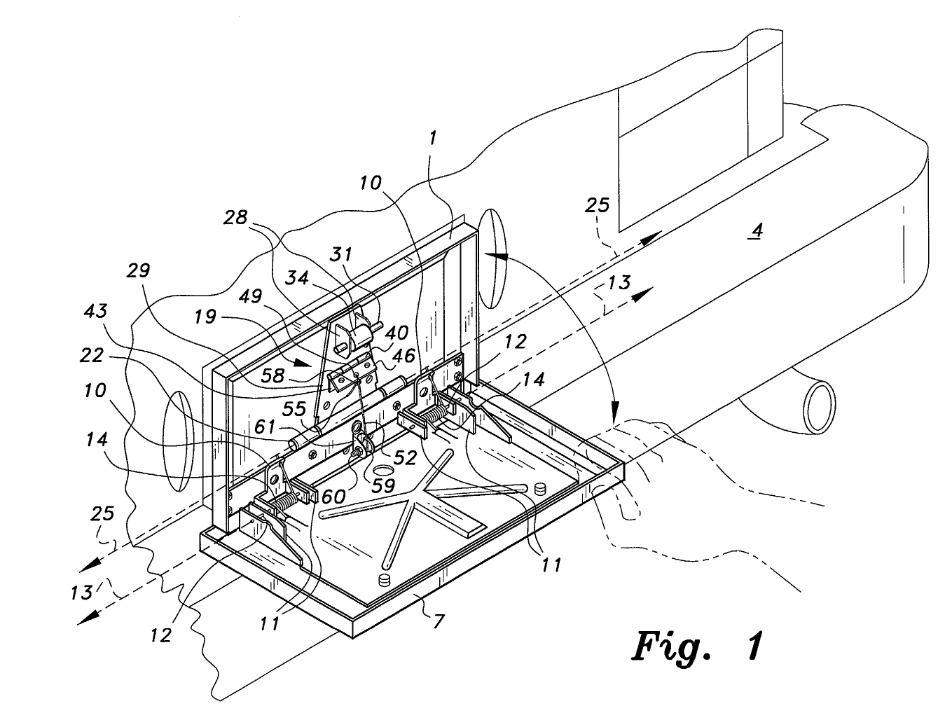

As best shown in FIGS. 1-3, a first embodiment of the inventive device is disclosed. A mounting plate 1 is mounted onto the rear end 4 of a motor vehicle with fasteners. Mounting plate 1 serves as a substrate for other features of the inventive device to be mounted to the motor vehicle. Support member 7 is mounted to mounting plate 1 via brackets 10, flanges 11 and shafts 12. Those skilled in the art will understand that the invention is not limited to mounting on the rear end of a vehicle, but also includes, but is not limited to, the front end of a vehicle or wherever else a license plate may be displayed.

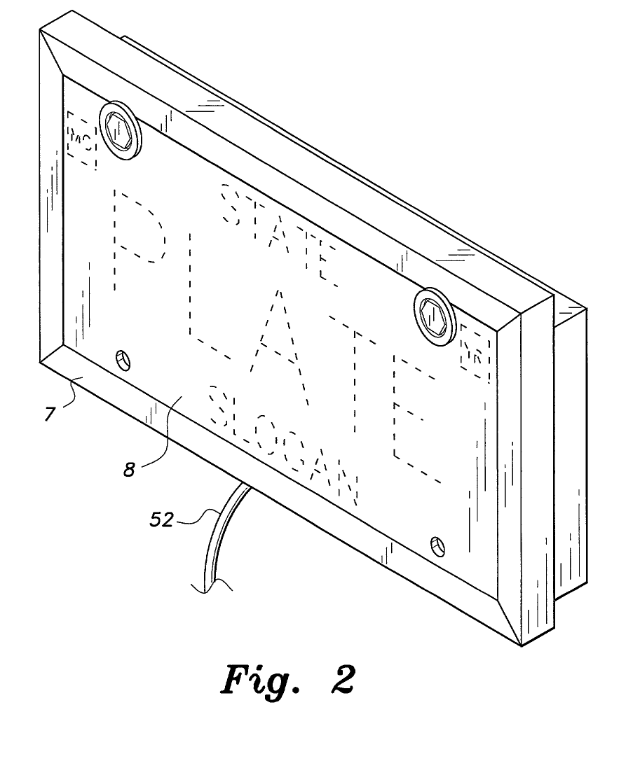

As best illustrated in FIG. 2, support member serves as a carrier and support for license plate 8. Although it is preferred that the license plate 8 be carried directly by the support member 7, those skilled in the art will appreciate that license plate 8 may be installed within a license plate frame or holder, which is itself carried by support member 7.

Referring again to FIG. 1, a joint created by brackets 10, flanges 11 and shafts 12 allows pivotal movement of support member 7 about an axis 13 extending through shafts 12. Springs 14 cooperate with brackets 10, flanges 11 and shafts 12 to bias support member 7 against mounting plate 1 in order to maintain the device in a closed position. As best illustrated in FIG. 2, license plate 8 is maintained in a generally vertical orientation when the device is in a closed position, such as when mud splatters or drivers with road rage are not a concern.

Referring again to FIG. 1, arm 19 is attached to mounting plate 1 by hinge 22 which allows arm 19 to be pivoted about an axis 25 extending through hinge 22. In FIG. 2, arm 19 has been partially pivoted about axis 25, while support member 7 has been more fully pivoted about axis 13 and is retained in a generally horizontal orientation by hand. While this configuration is shown in order to more clearly depict features on an underside of arm 19, biasing provided by the springs 14 urge arm 19 against support member 7 in the absence of manually holding the device open as depicted. Bracket 28 extends outward from the body 29 of arm 19 adjacent one end thereof and carries a shaft 31. Elastic roller 34 rides upon shaft 31 and nomally abuts against support member 7 due to the biasing of springs 14 (when support member 7 is not retained in a horizontal orientation by hand).

During operation of the invention, arm 19 is caused to be pivoted downwardly. As arm 19 pivots downardly, it will cause support member 7 to be correspondingly pivoted downwardly and the license plate 8 to be lowered from a generally vertical orientation into a generally horizontal orientation. In such a horizontal orientation, mud will tend not to collect on plate 8, and aggressive drivers in front of or behind the vehicle who are experiencing road rage will not be able to read any alphanumeric information displayed on license plate 8. Instead, a friendly message may be displayed on mounting member 1.

As best shown in FIG. 1, arm 19 includes a hinge 40 extending downwardly from body 29 of arm 19. Hinge 40 has a first end 43 secured to arm 19 and a second end 46 that is freely pivotable away from arm 19. Second end 46 includes an aperture 49 through which extends cable 52. Cable 52 has a first end, which is not depicted in FIG. 2 but which is attached to an actuator, and a second end 55, which is knotted and retained adjacent to aperture 49 by clip 58. Thus, second end 55 of cable 52 is secured to hinge 40.

Cable 52 extends across and is guided by pulley 59, which is itself mounted on shaft 60 carried by bracket 61. Bracket 61 is secured to mounting plate 1 via fasteners. During operation of the inventive device, cable 52 is pulled in the direction of the first end. As tension is placed on cable 52 and second end 55 is pulled away from hinge 40, hinge 40 is tugged downwardly, thereby causing arm 19 to be pivoted downwardly. As a result, support member 7 is correspondingly pivoted downwardly and license plate 8 is lowered to a generally horizontal orientation.

The first embodiment of the invention is not limited to the above description. For example, while it is preferred that support member 7 and arm 19 be mounted to mounting plate 1, those skilled in the art will understand that support member 7 and arm 19 may be mounted directly to the vehicle without mounting plate 1.

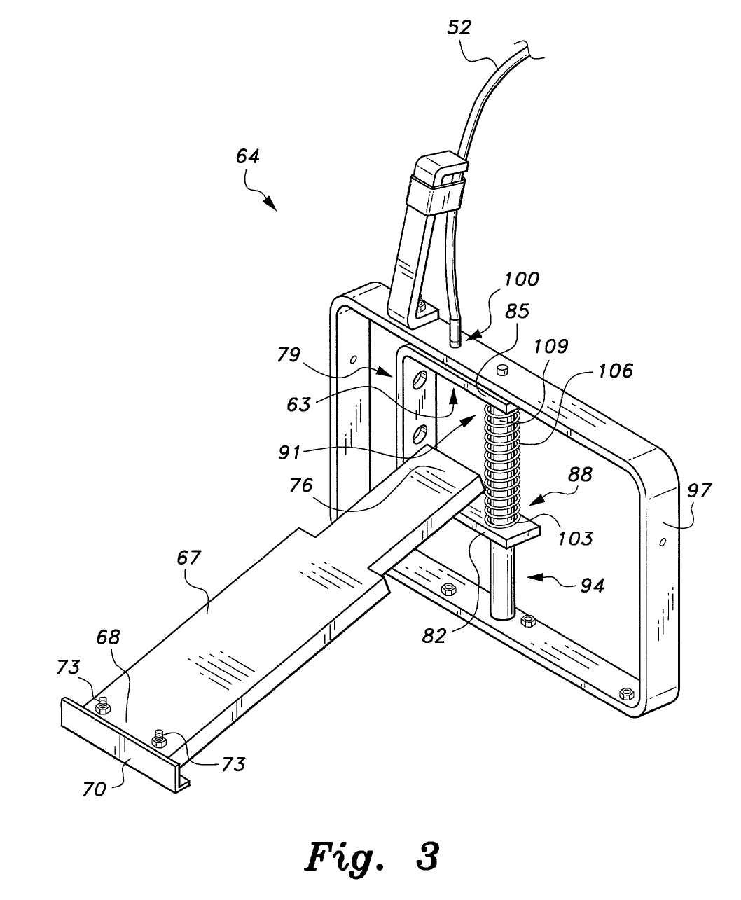

As best shown in FIG. 3, first end 63 of cable 52 extends to actuator 64. Cable 52 connects the inventive device illustrated in FIGS. 1-2 to the actuator illustrated in FIG. 3. When actuator 64 is located in a driver's compartment of the vehicle and the license plate 8 is located at the rear end of the vehicle, those skilled in the art will understand how to string cable 52 through the vehicle to these two locations. As explained above, the first embodiment of the inventive device and the actuator together form the first embodiment of the inventive system. Actuator 64 includes a pedal 67, one end 68 of which is mounted to bracket 70 via fasteners 73. Bracket 70 may rest upon, or be mounted to, the floor of a vehicle in front of the driver's seat, or anywhere else desired in or on the vehicle that will allow the operator to remotely actuate the actuator 64. The other end 76 of pedal 67 is loosely mounted to U-shaped bracket 79. Legs 82, 85 of U-shaped bracket 79 include apertures 88, 91 through which extends guide rail 94. Guide post 94 is mounted to frame 97, which may also be mounted to the floor of a vehicle, or anywhere else in or on the vehicle. First end 63 of cable 52 extends through aperture 100 in frame 97 and is fastened to, or retained upon leg 85. A lower end 103 of a spring 106 is secured to guide post 94 while an upper end 104 of spring 106 abuts, but is not secured to, leg 82, so that spring 106 biases U-shaped bracket 79 toward a top portion 109 of guide post 94. While it is preferred that the actuator be a manually operated pedal 67, those skilled in the art will understand that arm 19 may be actuated by any number of devices, including, but not limited to, an electric motor, an electric motor engaging the arm with gear(s), a manually operated button, a hydraulically actuated arm or gears, a pneumatically operated arm or gears, etc, any of which could be located anywhere on the vehicle so long as the operator actuates them from a location remote from the license plate.

The first embodiment of the system may be operated as follows. The operator depresses pedal 67. Downward movement of pedal 67 pulls cable 52, resulting in a downward pull on hinge 40. Downward movement of hinge 40 causes arm 19 to move pivotally downward against support member 7, thereby lowering support member 7 into a generally horizontal orientation. Since license plate 8 is carried by support member 7, it, too, is lowered into a generally horizontal orientation. In order to return the license plate 8 to its original position, the operator need only release pressure on pedal 67 and the biasing provided by the springs 14 will urge support member 7 against mounting member 1.

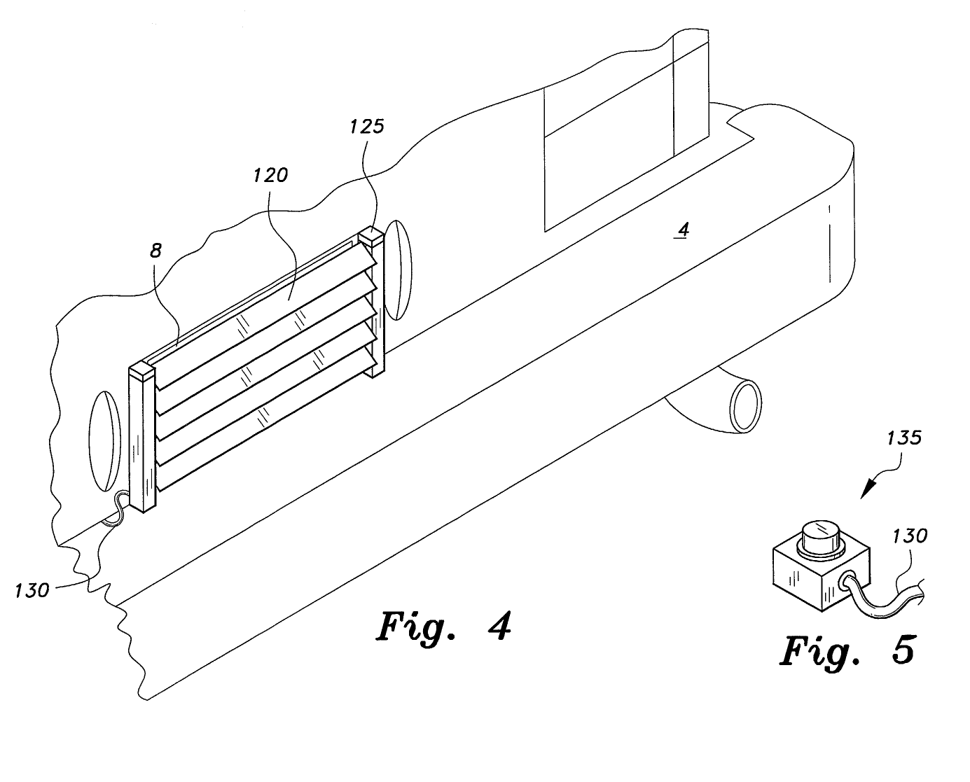

As best shown in FIGS. 4-5, a second embodiment of the invention is disclosed. A plurality of louvers 120 extend across license plate 8 and are engaged by securing members 125. Each of louvers 120 is pivotably moveable between a first orientation in which alphanumeric information displayed by license plate 8 is observable, for example by an aggressive driver behind the vehicle, and a second orientation in which the information is not observable. Securing members 125 are fastened to rear end 4. In the second embodiment, actuator 135 is a push button that sends an electric signal powered by the vehicle's battery via connector 130 to louvers 120 by way of securing member 125. When actuator 135 is actuated, the signal sent by connector 130 causes each of the louvers 120 to move from the first orientation to the second orientation, thereby preventing unwanted observation of the information. Those skilled in the art will understand that the invention is not limited to mounting on the rear end of a vehicle, but also includes, but is not limited to, the front end of a vehicle or wherever else a license plate may be displayed. Those skilled in the art will also understand that the second embodiment is not limited to the above described configuration. For example, the actuator may be a pedal, switch, dial or the like, the connector may be a cable, pneumatic hose, hydraulic hose or the like, and the louvers may also be moved by manual force, hydraulic force, pneumatic force or the like, that is released by actuation of the actuator.

It is to be understood that the present invention is not limited to the embodiment described above, but encompasses any and all embodiments within the scope of the following claims.

I claim:

1. A device for remotely controlling movement of a license plate of a vehicle from a generally vertical first orientation to a second orientation which is at an angle to the first orientation, said device comprising:
a support member for supporting the license plate and securing the license plate to the vehicle, said support member being moveable from said first orientation to said second orientation;
an arm engaging said support member and being moveable between first and second positions, wherein movement of said arm from the first position to the second position causes said support member to be moved from said first orientation to said second orientation.

2. The device of claim 1, wherein:
said support member is pivotable about an axis from said first orientation to said second orientation.

3. The device of claim 1, wherein:
said arm is pivotable about an arm pivot axis from said first position to said second position.

4. The device of claim 1, further comprising:
a mounting member engaging said arm and support member for mounting said arm and support member to the vehicle.

5. The device of claim 4, further comprising:
at least one hinge operatively associated with said mounting member and said support member for allowing pivotal movement of said support member from said first and second orientations.

6. The device of claim 5, further comprising:
at least one spring engaging said at least one hinge for biasing said support member against said mounting member.

7. The device of claim 4, further comprising:
at least one hinge engaging said arm and said mounting member for allowing pivotal movement of said arm between said first and second positions.

8. The device of claim 1, further comprising:
a cable having end adapted for engagement with an actuator and a second end attached to said arm, wherein actuation of the actuator pulls said second end thereby causing movement of said arm between said first and second positions.

9. The device of claim 8, further comprising:
a pulley engaging said cable for guiding said cable as said second end is pulled by the actuator.

10. The device of claim 1, wherein:
said support member is pivotable about a first axis from the first orientation to the second orientation; and
said arm is pivotable about a second axis between said first and second positions.

11. The device of claim 10, further comprising:
a mounting member engaging said arm and support member for mounting said arm and support member to the vehicle.

12. The device of claim 11, further comprising:
at least one hinge engaging said mounting member and said support member for allowing pivotal movement of said support member from said first orientation to said second orientation.

13. The device of claim 12, further comprising:
at least one spring engaging said at least one hinge for biasing said support member against said mounting member.

14. The device of claim 11, further comprising:
at least one hinge operatively associated with said arm and said mounting member for allowing pivotal movement of said arm between said first and second positions.

15. A system for remotely controlling movement of a license plate of a vehicle from a generally vertical first orientation to a second orientation which is at an angle to the first orientation, said system comprising:
the device of claim 1; and
an actuator engaging said arm for causing said arm movement of said arm from said first position to said second position.

16. The system of claim 15, wherein:
said actuator is a manually operated pedal.

17. The system of claim 16, further comprising:
a cable having a first end operatively connected to said actuator and a second end operatively connected to said arm.

18. The system of claim 15, further comprising:
at least one hinge engaging said mounting member and said support member for allowing pivotal movement of said support member from said first orientation to said second orientation; and
at least one spring engaging said at least one hinge for biasing said support member against said mounting member.

19. The system of claim 15, wherein:
said actuator is actuated by an operator of the vehicle at a location remote from the license plate.

20. A system for preventing unwanted observation of alphanumeric information displayed on a license plate of a vehicle, comprising:
a plurality of louvers adapted for extending across the license plate and being moveable between a first orientation in which the alphanumeric information may be read and a second orientation in which the alphanumeric information may not be read;
a securing member engaging said plurality of louvers and adapted to secure said plurality of louvers to the vehicle; and
an actuator adapted for mounting to a driver's compartment of the vehicle and engaging said plurality of louvers, wherein actuation of said actuator causes said plurality of louvers to move from said first orientation to said second orientation.
